(19) United States
(12) Patent Application Publication
(10) Pub. No.: US 2016/0170185 A1
(43) Pub. Date: Jun. 16, 2016

(54) IRIS RECOGNITION OPTICAL SYSTEM HAVING SHORT TOTAL LENGTH

(71) Applicant: HOLY STONE ENTERPRISE CO., LTD., Taipei City (TW)

(72) Inventor: Moon Hyun KIM, Yongin-City (KR)

(21) Appl. No.: 14/962,701

(22) Filed: Dec. 8, 2015

(30) Foreign Application Priority Data
Dec. 11, 2014 (KR) 10-2014-0178812
May 6, 2015 (KR) 10-2015-0063050

(51) Int. Cl. G02B 13/00; G06K 9/00; G02B 17/08

(52) U.S. Cl. CPC G02B 13/0065; G02B 17/0808; G02B 13/003; G02B 17/086; G06K 9/00597

(57) ABSTRACT

An iris recognition optical system having short total length includes first lens having positive diopter and second lens having negative diopter and axially disposed in alignment with first lens. The first lens includes second reflecting surface located on object side around optical axis, first transmissive surface with concave curvature located on object side around second reflecting surface and exhibiting vertical profile relative to said optical axis, second transmissive surface located on image side around optical axis, and first reflecting surface located on image side around second transmissive surface. As first lens is configured to provide two opposite reflecting surfaces, focal length of system can be greatly shortened, and therefore, the system can be installed in cell phone, smart phone, tablet computer, notebook or any other low-profile mobile electronic device, allowing product user to easily and stably get iris images from a distance of about 300 mm.

This application claims the priority benefits of Korean patent application numbers 10-2015-0063050 and 10-2014-0178812, respectively filed on May 6, 2015 and Dec. 11, 2014.

### BACKGROUND OF THE INVENTION

1. Field of the Invention

The present invention relates to multilayered ceramic technology and more particularly, to an iris recognition optical system having short total length, which uses a lens having two opposing reflecting surfaces to shorten the focal length, allowing the system to be installed in a cell phone, smart phone, tablet computer, notebook or any other low-profile mobile electronic device for iris recognition.

2. Description of the Related Art

Recently, with access control systems, computer security system as the center, the technology of biometrics that uses human characteristics to confirm personal identity of biometric technology is increasingly in vogue. Biometric identification technology has been widened from the mainstream of fingerprint recognition in the early days to the application range of iris recognition, voice recognition or vein recognition.

Especially the adjustable diaphragm of iris around the pupil of the eye, iris in shape no penetrance genetic, surpassing the anatomical shape, even with the iris oviparous twins also vary. When compared to fingerprint identification, iris recognition exhibits a more distinctive identification feature, so the application instance of iris recognition technology is increasingly being used in different applications.

In iris recognition, the identification process is carried out by gathering one or more detailed images of the eye with an optical system, and then using a specialized computer program to compare the subject's iris pattern with iris codes stored in a database.

In addition, in order to accurately obtain the characteristics of an iris image with a computer software, if the iris diameter is 11˜12 mm and the object distance is 300 mm, the longitudinal image of the longitudinal image sensed by the image sensor of the camera (video camera) module shall generally contain more than 200 pixels.

The most compact ( 1/10 inch) VGA level sensor (640*480) has the pixel size of about 2.25 μm, therefore the size of 200 pixels is about 0.45 mm, compared with the iris size 12 mm, the magnification of the optical system is 0.0375 times. So, when a user uses a VGA level sensor to capture an iris image at a distance not very inconvenient (about 300 mm), and in order to obtain a satisfactory iris image, the VGA level sensor must have the magnification ratio over the above-described level.

When an optical system consisting of two lenses (L1, L2), as illustrated in FIG. 1, is used to achieve this magnification ratio, the focal length must be over 12 mm. To obtain such a focal length, even with a 1/10 inch VGA-level sensor and 50% of the unilateral size (0.9 mm) of the image sensor to make the iris image composition, the total length of the optical system (the distance from the front side of the first lens to the sensing surface of the image sensor) must be about 10.9 mm.

For installation in the optical system of a regular security equipment, this total length should not cause a big problem; however, for installation in a smart phone, tablet computer, notebook computer or any other mobile electronic product of overall thickness smaller than 10 mm, this design of optical system is not workable.

And even with a camera that supports over 16 million pixels, shooting under a normal shooting mode but not in a close-up view, such as iris diameter is 11˜12 mm and the object distance is 300 mm, the minimum acceptable iris diameter for iris imaging will be 150 pixels, thus, it will be difficult to process the image with a computer software.

Further, fully enhancing the magnification ratio of the optical system can obtain an iris image over 200 pixels, however, increasing the magnification ratio relatively widens the focal length, and if the focal length is widened, the total length of the optical system will be increased. Therefore, to regular optical systems, unlimited increase of magnification ratio is not allowed.

Moreover, in close-up shooting, it is easy to obtain an iris image over 200 pixels, however, the application under this close-up shooting mode is extremely inconvenient, under the reference of the normal applicable distance (about 300 mm) of regular mobile electronic products, you must shorten the total length of the optical system.

Further, Patent Document 1 is the document of Korean Patent Publication No. 10-2008-0049022. FIG. 2 illustrates an optical system disclosed in the annexed patent document 1, which comprises a bi-convex spherical lens (2A), a bi-concave spherical lens (3A), a visible light filter (4A), a package glass (6) and an image sensor (5) arranged in a proper order from the object side.

However, in Patent Document 1, the thickness of the bi-convex spherical lens (2A) is 2.92 mm; the thickness of the bi-concave spherical lens (3A) is 3.00 mm; the distance between the bi-concave spherical lens (3A) and the visible light filter (4A) is 2.45 mm; the thickness of the visible light filter (4A) is 3.00 mm. Obviously, the total length of the optical system is over 20 mm.

Therefore, the iris recognition optical system of Patent Document 1 is not suitable for use in smart phones and other low-profile small electronic products.

Therefore, it is desirable to provide an iris recognition optical system, which has a short total length and is practical for use in a cell phone, smart phone, tablet computer, notebook or any other low-profile mobile electronic device, allowing the product user to easily and stably get iris images from a short distance.

### SUMMARY OF THE INVENTION

The present invention has been accomplished under the circumstances in view. It is one object of the present invention to provide an iris recognition optical system having short total length, which comprises a first lens (L1) having a positive (+) diopter, and a second lens (L2) having a negative (−) diopter and axially disposed in alignment with the first lens (L1). The first lens (L1) comprises a second reflecting surface (S3) located on an object side around an optical axis thereof, a first transmissive surface (S1) located on the object side around the second reflecting surface (S3) and selectively exhibiting a vertical or concave profile relative to the optical axis, a second transmissive surface (S4) located on an image side thereof around the optical axis, and a first reflecting surface (S2) located on the image side around the second transmissive surface (S4).

Further, the first reflecting surface (S2) and the second reflecting surface (S3) exhibit a convex profile on the image side; the second transmissive surface (S4) exhibits a concave profile on the image side.

Further, the first reflecting surface (S2), second reflecting surface (S3) and second transmissive surface (S4) of the first lens (L1) are aspheric; the second lens (L2) has two opposite surfaces (S5,S6) thereof made aspheric.

Further, the optical system has a total length T (the distance from the front surface of the first lens to the sensing surface of the image sensor (5)); if the effective focal length of the optical system is F, the optical system meet the conditional expression of T/F<0.65.

Further, the first transmissive surface (S1) exhibits a concave curvature profile on the object side, and meets the conditional expression of −100,000<radius of curvature (S1)<−100.

As the first lens of the iris recognition optical system of the invention is configured to provide two opposite reflecting surfaces, the focal length of the system can be greatly shortened, and therefore, the system can be installed in a cell phone, smart phone, tablet computer, notebook or any other low-profile mobile electronic device, allowing the product user to easily and stably get iris images from a distance of about 300 mm.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a schematic drawing illustrating a structure of iris recognition optical system according to the prior art.

FIG. 2 is a schematic drawing illustrating another structure of iris recognition optical system according to the prior art.

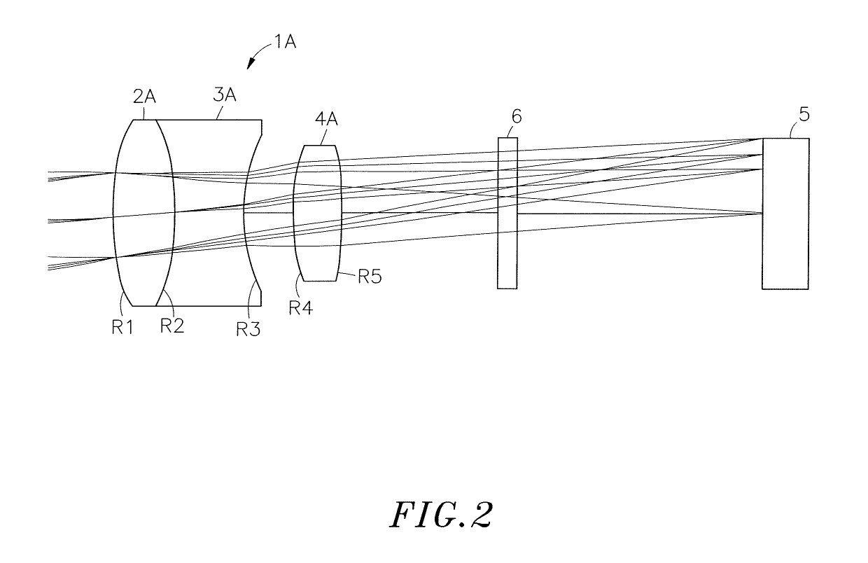

FIG. 3 is a schematic drawing illustrating a structure of an iris recognition optical system in accordance with a first embodiment of the present invention.

FIG. 4 is a deviation diagram obtained from the iris recognition optical system in accordance with the first embodiment of the present invention.

FIG. 5 is a schematic drawing illustrating a structure of an iris recognition optical system in accordance with a second embodiment of the present invention.

FIG. 6 is a deviation diagram obtained from the iris recognition optical system in accordance with the second embodiment of the present invention.

FIG. 7 is a schematic drawing illustrating a structure of an iris recognition optical system in accordance with a third embodiment of the present invention.

FIG. 8 is a deviation diagram obtained from the iris recognition optical system in accordance with the third embodiment of the present invention.

### DETAILED DESCRIPTION OF THE PREFERRED EMBODIMENT

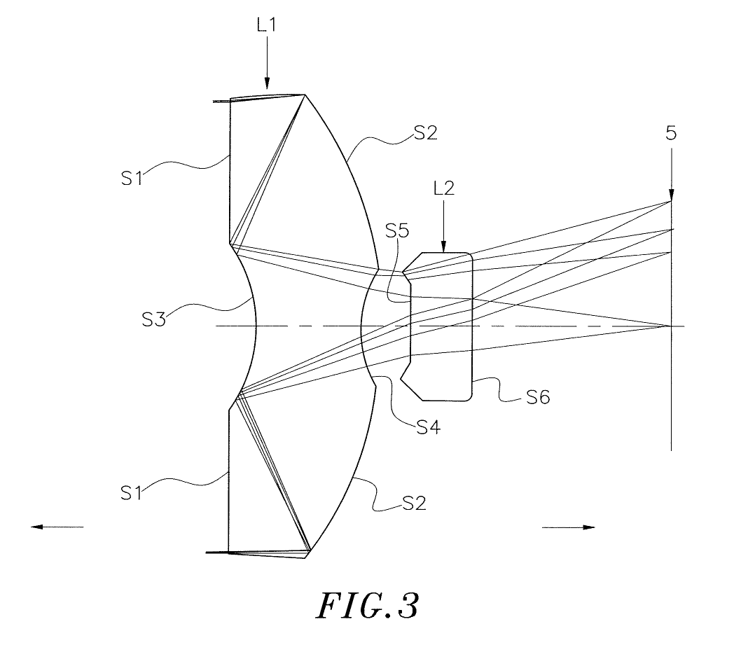

Referring to FIGS. 3, 5 and 7, an iris recognition optical system having short total length in accordance with the present invention is shown. The iris recognition optical system having short total length comprises a first lens (L1) having a positive (+) diopter, and a second lens (L2) having a negative (−) diopter and axially disposed in alignment with the first lens (L1). Further, a spacer (not shown) can be disposed between the second lens (L2) and the image sensor (5).

Further, the first lens (L1) in this embodiment has reflecting surfaces respectively located on opposing object side and image side thereof.

More specifically, the first lens (L1) comprises a second reflecting surface (S3) located on the object side around the optical axis, a first transmissive surface (S1) located on the object side around the second reflecting surface (S3), a second transmissive surface (S4) located on the image side around the optical axis, and a first reflecting surface (S2) located on the image side around the second transmissive surface (S4).

When light is incident onto the first transmissive surface (S1), it is reflected by the first reflecting surface (S2) on the image side toward the second reflecting surface (S3) and then reflected by the second reflecting surface (S3) through the second transmissive surface (S4) into the second lens (L2).

The first transmissive surface (S1) preferably exhibits a vertical or concave profile relative to the optical axis. Although lenses with two reflecting surfaces have been introduced in conventional full-range optical systems or panorama optical systems, these optical systems are of wide-angle lens designs where the first transmissive surface (S1) on the object side exhibits a large convex curvature. However, as previously stated, for iris recognition application, it is necessary to narrow from wide field-of-view to narrow field-of-view, and therefore, it is not practical to apply the first transmissive surface (S1) to this design

At a distance of about 300 mm, in order to properly capture the iris, it needs to show a high rate on the narrow field-of-view, and for this, the first transmissive surface (S1) of the first lens (L1) in accordance with the present invention preferably exhibits a small concave curvature profile on the object side, or a vertical or small concave curvature profile relative to the optical axis.

Enabling the first transmissive surface (S1) to exhibit the aforesaid concave curvature profile must meet the following conditional expressions.

−100,000<radius of curvature<−100 <Conditional Expression 1>

Further, the first reflecting surface (S2) and second reflecting surface (S3) of the first lens (L1) respectively exhibit a convex profile on the image side, and respectively coated with a layer of reflective material such as aluminum or silver, or bonded with a layer of reflective film. Further, the second transmissive surface (S4) of the first lens (L1) preferably exhibits a concave profile.

According to this embodiment, the first lens (L1) and the second lens (L2) are plastic lenses, however, the material is not to be limited to plastics.

According to this embodiment, the first reflecting surface (S2), second reflecting surface (S3) and second transmissive surface (S4) of the first lens (L1) are aspheric; the two opposite surfaces (S5,S6) of the second lens (L2) are aspheric.

More particularly, in this embodiment, in iris recognition, even with sufficient field of view and magnification ratio (or focal length), the optical system should render a shorter total length to meet the above Conditional Expression 1 in order for use in cell phones, smart phones or tablet computers, and therefore, the design of the above-described lenses is created.

Telephoto ratio (T/F)<0.65 <Conditional Expression 2>

T: total length of optical system (the distance from the front surface of the first lens to the sensing surface of the image sensor (5)); F: effective focal length of optical system.

In fact, if getting rid of the conditions stated above, such as the object distance 300 mm as a reference, the total length will become too long to be mounted in a cell phone, smart phone, tablet computer, notebook computer or any other small low-profile mobile electronic product.

Embodiments of iris recognition optical system having short total length that meet the above-stated conditional expressions in accordance with the present invention are outlined hereinafter.

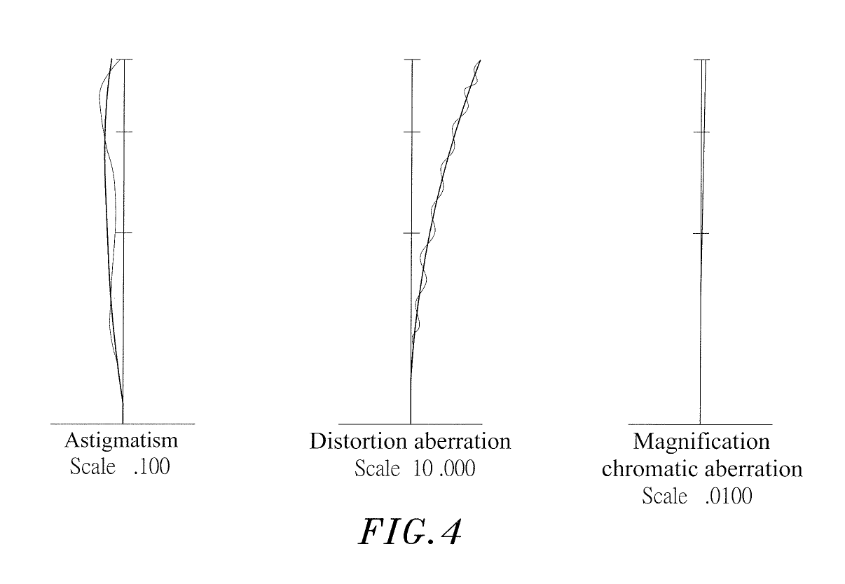

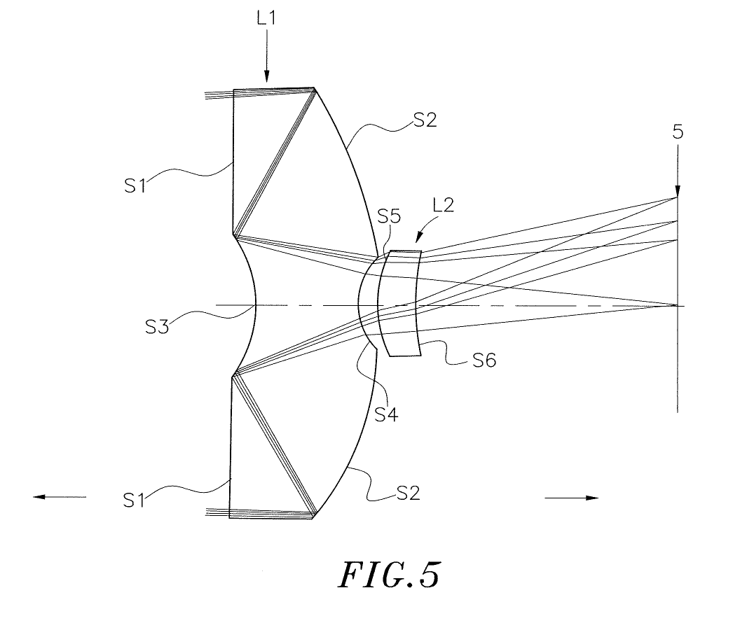

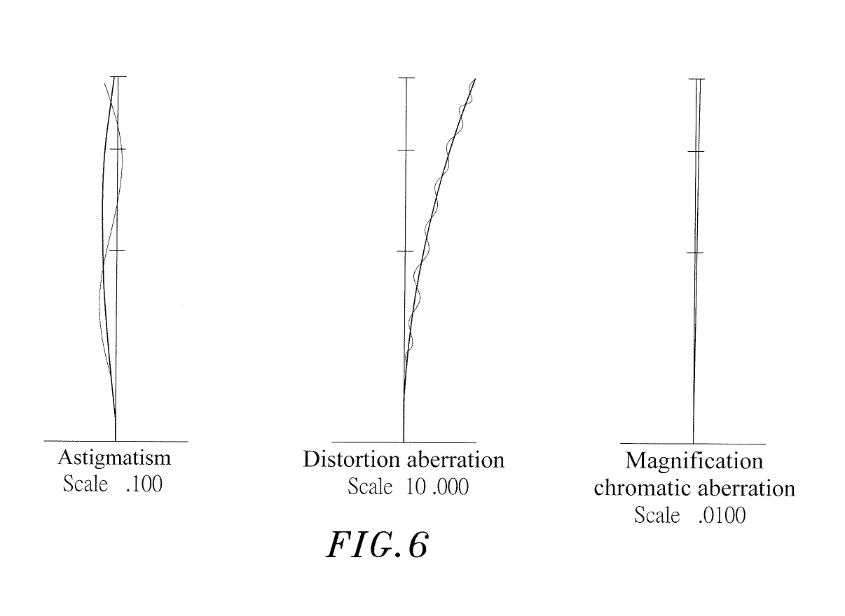

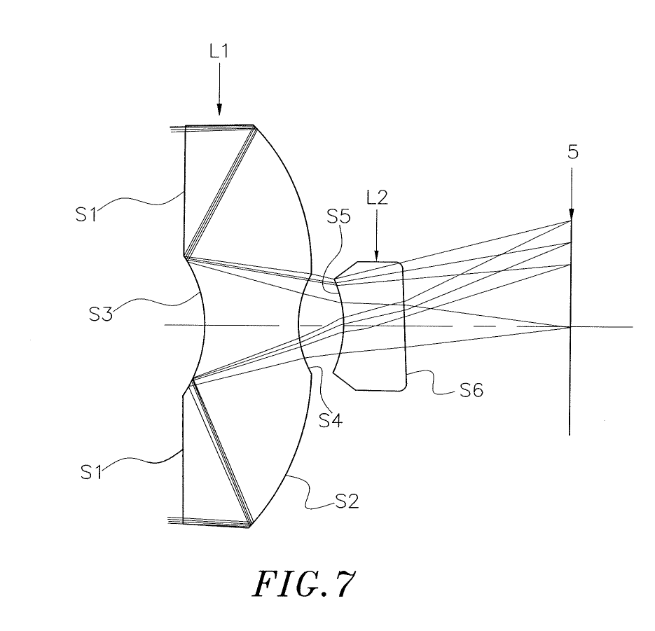

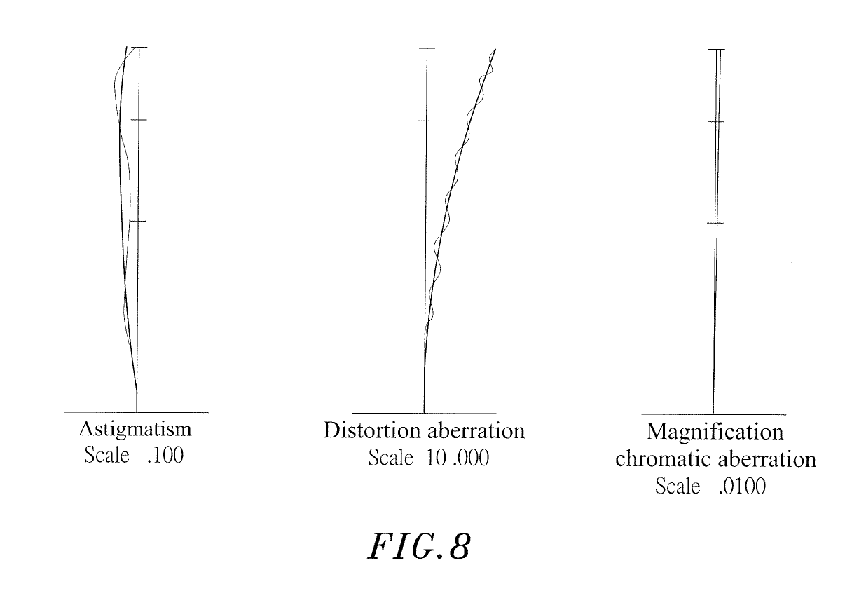

FIGS. 3 and 4 are structural view and deviation diagram of an iris recognition optical system in accordance with a first embodiment of the present invention. FIGS. 5 and 6 are structural view and deviation diagram of an iris recognition optical system in accordance with a second embodiment of the present invention. FIG. 7 is a structural view of an iris recognition optical system in accordance with a third embodiment of the present invention, and FIG. 8 is a deviation diagram obtained from this iris recognition optical system.

The following Table I illustrates the data of radius of curvature, thickness and index of refraction of the lenses used in the iris recognition optical system in accordance with the first embodiment of the present invention. Table II illustrates the aspheric data of the surfaces of the lenses used in the optical system in accordance with the first embodiment of the present invention.

TABLE I

| | No. of surface | | | | |
|---|---|---|---|---|---|
| | (S) | R | D | ND | Remarks |
| | S0 | | 340 | | Object surface |
| L1 | S1 | −250 | 1.085 | 1.53651 | |
| | S2 | −2.58379 | −0.9263 | 1.53651 | Reflecting surface |
| | S3 | −0.93204 | 0.78 | 1.53651 | Reflecting surface |
| | S4 | 0.56644 | 0.3605 | | |
| L2 | S5 | −14.31325 | 0.44 | 1.53651 | |
| | S6 | 11.58778 | 1.4309 | | |
| | S7 | | | | Image surface |

TABLE II

| | L1 | | | L2 | |
|---|---|---|---|---|---|
| | S2 | S3 | S4 | S5 | S6 |
| R | −2.58379000E+00 | −9.32040000E−01 | 5.66440000E−01 | −1.43132500E+0.1 | 1.15877800E+01 |
| K | −1.87072928E+00 | −4.03880273E+00 | 2.47448303E−01 | −6.18129563E+03 | −2.56235763E+03 |
| A | −6.30927358E−03 | −2.72457813E−01 | −1.84998923E+00 | −1.58524782E+00 | −3.40455984E−01 |
| B | 3.46321305E−04 | 5.22078730E−01 | −4.17795323E+00 | −1.17131619E+01 | −2.40440126E+00 |
| C | −8.31489067E−06 | −6.75269028E−01 | −9.32592747E+00 | 8.50392843E+01 | 6.27425467E+00 |
| D | −1.22707403E−06 | 3.80840433E−01 | −5.90305414E+01 | −6.18976803+02 | −5.39268030E+00 |

The following Table III illustrates the data of radius of curvature, thickness and index of refraction of the lenses used in the iris recognition optical system in accordance with the second embodiment of the present invention. Table IV illustrates the aspheric data of the surfaces of the lenses used in the optical system in accordance with the second embodiment of the present invention.

TABLE III

| | No. of surface | | | | |
|---|---|---|---|---|---|
| | (S) | R | D | ND | Remarks |
| | S0 | | 248 | | Object surface |
| L1 | S1 | 0 | 1.2455 | 1.53651 | |
| | S2 | −2.95465 | −1.0723 | 1.53651 | Reflecting surface |
| | S3 | −1.04766 | 0.8756 | 1.53651 | Reflecting surface |
| | S4 | 0.48962 | 0.1981 | | |
| L2 | S5 | 162.80751 | 0.3 | 1.53651 | |
| | S6 | 21.67592 | 2.195 | | |
| | S7 | | | | Image surface |

TABLE IV

| | L1 | | | L2 | |
|---|---|---|---|---|---|
| | S2 | S3 | S4 | S5 | S6 |
| R | −2.95465000E+00 | −1.04766000E−00 | 4.89620000E−01 | 1.62807510E+0.2 | 2.16759200E+01 |
| K | −1.89208167E+00 | −5.27192054E+00 | −2.16904384E−01 | −6.44598227E+03 | −2.93351696E+03 |
| A | −4.18993824E−03 | −2.83445189E−01 | 9.26224986E−01 | 2.24663936E+00 | 1.05025121E−00 |
| B | 4.82133909E−05 | 3.75915909E−01 | −1.30608998E+01 | −5.52747085E+00 | 1.59567382E+00 |
| C | 3.05372104E−05 | −1.37762351E−01 | 1.50567970E+02 | 5.96654230E+01 | −2.17318292E+01 |
| D | −3.53014562E−06 | −1.98321694E−01 | −5.39441560E+02 | −1.49623811E+02 | 9.44770978E+01 |

The following Table V illustrates the data of radius of curvature, thickness and index of refraction of the lenses used in the iris recognition optical system in accordance with the third embodiment of the present invention. Table VI illustrates the aspheric data of the surfaces of the lenses used in the optical system in accordance with the third embodiment of the present invention.

TABLE V

| | No. of surface | | | | |
|---|---|---|---|---|---|
| | (S) | R | D | ND | Remarks |
| | S0 | | 340 | | Object surface |
| L1 | S1 | 0 | 1.0869 | 1.53651 | |
| | S2 | −2.58194 | −0.9252 | 1.53651 | Reflecting surface |
| | S3 | −0.92668 | 0.78 | 1.53651 | Reflecting surface |
| | S4 | 0.55929 | 0.3444 | | |
| L2 | S5 | −16.58377 | 0.531 | 1.53651 | |
| | S6 | 10.3833 | 1.363 | | |
| | S7 | | | | Image surface |

TABLE VI

| | L1 | | | L2 | |
|---|---|---|---|---|---|
| | S2 | S3 | S4 | S5 | S6 |
| R | −2.58194000E+00 | −9.26680000E−01 | 5.59290000E−01 | −1.658377500E+0.1 | 1.03833000E+01 |
| K | −1.81804725E+00 | −4.51497083E+00 | 2.31939022E−01 | −6.27339331E+03 | −2.85777822E+03 |
| A | −5.91103377E−03 | −3.57008083E−01 | −1.94071475E+00 | −1.41405104E+00 | −1.18587918E−01 |
| B | 2.60308025E−04 | 7.58289526E−01 | −4.13084447E+00 | −9.49043858E+00 | −2.23095660E+00 |
| C | 1.44688906E−05 | −1.08983777E−00 | −9.77376149E+00 | 6.20186386E+01 | 5.82349050E+00 |
| D | −4.21762108E−06 | 7.03462147E−01 | −6.23921925E+01 | −4.94530574E+02 | −5.14197944E+00 |

In the above-described Table II, Table IV and Table VI, K is the conic constant; A, B, C and D are the aspheric coefficients which can be applied to the following mathematical formula 1 associated with aspheric shape.

$$Z = \frac{{cY}^{2}}{1 + \sqrt{1 - ( 1 + K ) {c}^{2} {Y}^{2}}} + {AY}^{4} + {BY}^{6} + {CY}^{8} + {DY}^{10} \qquad [ Mathematical Formula 1 ]$$

in which, Z is the distance from the vertex of the lens to the optical axis; Y is the distance of the optical axis in the vertical direction; c is the reciprocal of the radius of curvature (r) of the lens.

The effective focal length, total length and telephoto ratio (T/F) of the optical system of the first, second and third embodiments of the present invention are as illustrated in the following Table VII.

TABLE VII

| | | Embodiment | Embodiment |
|---|---|---|---|
| Classification | Embodiment 1 | 2 | 3 |
| Focal length of first lens | 9.89 | 12.09 | 9.9 |
| Focal length of second lens | −11.87 | −46.64 | −11.82 |
| Effective focal length (efl) | 10.85 | 12.42 | 10.81 |
| Total length (T) | 3.1701 | 3.74149 | 3.1801 |
| Telephoto ratio (T/efl) | 0.29 | 0.30 | 0.29 |

As illustrated in Table VII, if the object distances are 340 mm, 248 mm and 340 mm, the effective focal lengths (efl) of the iris recognition optical systems in accordance with the first, second and third embodiments of the present invention are 10.85 mm, 12.42 mm and 10.81 mm respectively.

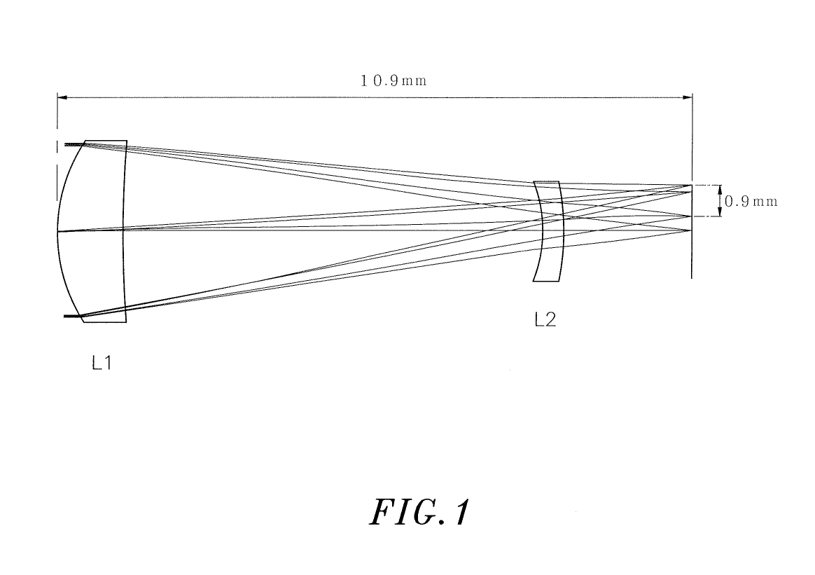

These effective focal lengths show a significant difference from the prior art iris recognition optical system shown in FIG. 1. Further, the total lengths (T) of the iris recognition optical systems in accordance with the first, second and third embodiments of the present invention are 3.17 mm, 3.74 mm and 3.18 mm respectively, about ⅓ less when compared to the aforesaid prior art design. Therefore, the invention greatly shortened the total length of the optical system.

An iris recognition optical system having such a short total length can be used in any of a variety of latest thinnest designs of cell phones, smart phones, tablet computers and notebook computers that have been put on the market as well as most of portable electronic products and other similar small size electronic products.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An iris recognition optical system having short total length, comprising:
a first lens having a positive (+) diopter; and
a second lens having a negative (−) diopter and axially disposed in alignment with said first lens;
wherein said first lens comprises a second reflecting surface located on an object side around an optical axis thereof, a first transmissive surface located on said object side around said second reflecting surface and selectively exhibiting a vertical or concave profile relative to said optical axis, a second transmissive surface located on an image side thereof around said optical axis, and a first reflecting surface located on said image side around said second transmissive surface.

2. The iris recognition optical system having short total length as claimed in claim 1, wherein said first reflecting surface and said second reflecting surface exhibit a convex profile on said image side; said second transmissive surface exhibits a concave profile on said image side.

3. The iris recognition optical system having short total length as claimed in claim 1, wherein said first reflecting surface, said second reflecting surface and said second transmissive surface of said first lens are aspheric; said second lens has two opposite surfaces thereof made aspheric.

4. The iris recognition optical system having short total length as claimed in claim 3, wherein said optical system has a total length T (the distance from the front surface of said first lens to the sensing surface of an image sensor); if the effective focal length of the optical system is F, the optical system meet the conditional expression of T/F<0.65.

5. The iris recognition optical system having short total length as claimed in claim 1, wherein said optical system has a total length T (the distance from the front surface of said first lens to the sensing surface of an image sensor); if the effective focal length of the optical system is F, the optical system meet the conditional expression of T/F<0.65.

6. The iris recognition optical system having short total length as claimed in claim 1, wherein said first transmissive surface exhibits a concave curvature profile on said object side, and meets the conditional expression −100,000<radius of curvature<−100.
